(19) United States
(12) Patent Application Publication
(10) Pub. No.: US 2025/0010513 A1
(43) Pub. Date: Jan. 9, 2025

(54) METHODS AND SYSTEMS FOR STIFFENING EXTRUDATES

(71) Applicant: CORNING INCORPORATED, CORNING, NY (US)

(72) Inventors: Ravindra Kumar Akarapu, San Diego, CA (US); Priyank Paras Jain, Horseheads, NY (US); Xinghua Li, Horseheads, NY (US); Amos James Mainville, Pine Valley, NY (US); Elias Panides, Horseheads, NY (US); Andrea Lynn Santen, Linden (DE); Kenneth Charles Sariego, Beaver Dams, NY (US); John Forrest Wight, Jr., CORNING, NY (US); Jia Zhang, Painted Post, NY (US)

(21) Appl. No.: 18/708,185

(22) PCT Filed: Nov. 15, 2022
(86) PCT No.: PCT/US2022/049933

§ 371 Date: May 7, 2024

Related U.S. Application Data
(60) Provisional application No. 63/283,768, filed on Nov. 29, 2021.

(51) Int. Cl. B28B 11/24; B28B 17/00

(52) U.S. Cl. CPC B28B 11/243; B28B 11/248; B28B 17/0081

(57) ABSTRACT

A system (100) for manufacturing an extrudate (10), such as a honeycomb body, is provided. The system comprises an extruder (102). The extruder is configured to form an extrudate from a wet mixture, such as a ceramic forming mixture. The system further comprises a radiative heat assembly (104). The radiative heat assembly is configured to heat the extrudate. The radiative heat assembly comprises one or more IR light sources (112). The one or more IR light sources are arranged as one or more rings around the extrudate. The system further comprises a differential pressure assembly (108). The differential pressure assembly is configured to remove at least a portion of water vapor from around the extrudate. The differential pressure assembly can direct an air flow out of a chamber (136) formed by a housing (132) surrounding the radiative heat assembly. Alternatively, the differential pressure assembly can direct an air flow into the chamber.

### CROSS REFERENCE TO RELATED APPLICATION

This application claims the benefit of priority under 35 U.S.C. § 119 of U.S. Provisional Application Ser. No. 63/283,768 filed on November 29,2021, the content of which is relied upon and incorporated herein by reference in its entirety.

### FIELD OF THE DISCLOSURE

The present disclosure is directed generally to methods and systems for drying an extrudate at high extrusion speeds.

### BACKGROUND

Extrusion processes are used to produce a wide variety of articles, including ceramic honeycomb bodies, such as those used as particulate filters and catalyst substrates. To produce the resulting article, water or other liquid vehicle may be mixed with a raw material (such as a ceramic-forming mixture) extruded through an extrusion die. The addition of water or other liquid vehicle may reduce the pressure needed to push the mixture through the die. Further, the addition of a liquid vehicle may reduce die-wear at a given speed. However, the added liquid vehicle can cause the resulting article to be soft when it exits the extruder. This softness can lead to deformation of the extruded article during or immediately following extrusion or in subsequent processing stages.

Accordingly, there is a need in the art to enable fast extrusion of sufficiently strong green ceramic bodies.

### SUMMARY

This disclosure generally relates to systems and methods for manufacturing an extrudate.

Generally, in one aspect, a system for manufacturing an extrudate is provided. The system comprises an extruder. The extruder is configured to form an extrudate from a wet mixture. According to an example, the wet mixture is a ceramic forming mixture. According to a further example, the extrudate has a honeycomb structure.

The system further comprises a radiative heat assembly. The radiative heat assembly is configured to heat the extrudate. According to an example, the radiative heat assembly comprises one or more infrared (IR) light sources. According to a further example, the one or more IR light sources are arranged as one or more rings around the extrudate.

The system further comprises a differential pressure assembly. The differential pressure assembly is configured to remove at least a portion of water vapor from around the extrudate. The differential pressure assembly can direct an air flow out of the chamber via a gap between the housing and the extrudate. Alternatively, the differential pressure assembly can direct an air flow into the chamber via the gap between the housing and the extrudate. According to an example, the differential pressure assembly is further configured to direct an air flow directed towards the extrudate. According to an alternate example, the differential pressure assembly is further configured to direct an air flow directed away from the extrudate.

According to an example, the system further comprises a brush-seal arranged between an annulus of the radiative heat assembly and the extrudate.

According to an example, the system further comprises an air bearing configured to support at least a portion of the extrudate after the extrudate is formed by the extruder.

According to an example, the system further comprises a temperature sensor. The temperature sensor is configured to detect a skin temperature of the extrudate. The system further comprises a controller. The controller is configured to adjust the radiative heat assembly. The radiative heat assembly is adjusted based on the skin temperature of the extrudate and a desired drying temperature.

According to an example, the system further comprises a housing arranged around the radiative heat assembly. The housing can be configured to reflect at least a portion of radiation generated by the radiative heat assembly towards the extrudate. According to an example, the housing forms a chamber around one of more IR light sources of the radiative heat assembly.

Generally, in another aspect, a method for manufacturing an extrudate is provided. The method comprises forming, via an extruder, an extrudate from a wet mixture.

The method further comprises heating, via a radiative heat assembly, the extrudate. According to an example, the radiative heat assembly comprises one or more IR light sources.

The method further comprises removing, via a differential pressure assembly arranged around the radiative heat assembly, at least a portion of water vapor from around the extrudate.

According to an example, the method further comprises supporting, via an air bearing, at least a portion of the extrudate after the extrudate is formed by the extruder.

According to an example, the method further comprises detecting, via a temperature sensor, a skin temperature of the extrudate.

According to an example, the method further comprises adjusting, via a controller, the radiative heat assembly based on the skin temperature of the extrudate and a desired drying temperature.

According to an example, the method further comprises conveying, via the extruder, the extrudate through an annulus formed by the radiative heat assembly.

According to an example, the method further comprises directing, via the differential pressure assembly, an air flow towards the extrudate. In an alternative example, the method further comprises directing, via the differential pressure assembly, an air flow away from the extrudate.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various examples.

FIG. 1 is a front view of an extruded honeycomb structure, according to an example.

FIG. 2 is a cross-sectional view of a drying assembly, according to an example.

FIG. 3 is a perspective view of a drying assembly and an extrudate, according to an example.

FIG. 4 is a schematic drawing of a system for manufacturing an extrudate, according to an example.

FIG. 5 is a schematic drawing of a system for manufacturing an extrudate, according to a further example.

FIG. 6 is a schematic drawing of a system for manufacturing an extrudate, according to an additional example.

FIG. 7 is a schematic drawing of a differential pressure assembly, according to an additional example.

FIG. 8 is a top view of an air bearing arranged with a drying assembly, according to an example.

FIG. 9 is a method for manufacturing an extrudate, according to an example.

FIG. 10 is a method for manufacturing an extrudate, according to a further example.

### DETAILED DESCRIPTION

This disclosure generally relates to systems and methods for manufacturing an extrudate, and in particular manufacturing at high speeds (such as 2 inches per second), as well as components and steps for drying the extrudate immediately following extrusion to prevent deformation during subsequent handling and processing. The extrudate is formed from a wet batch mixture, such as a ceramic-forming mixture of one or more ceramic or ceramic precursor materials mixed with a liquid vehicle such as water. The resulting extrudate can be a honeycomb structure, such as used in a particulate filter or catalyst substrate.

According to embodiments here, an extrudate is heated by a radiative heat assembly. The radiative heat assembly can comprise a plurality of infrared (IR) light sources. The IR light sources can be arranged to form one or more rings around the extrudate as it passes through the radiative heat assembly. The radiative heat assembly can be surrounded by a housing. The inner housing surface of the housing forms a chamber around the IR light sources (and therefore the extrudate as well), and is configured to reflect the radiation generated by the IR light sources towards the extrudate, resulting in more efficient drying. The inner housing surface can be polished to improve its reflective properties. The housing provides an additional benefit of maintaining a high air temperature around the extrudate during drying. The extrudate exits the radiative heat assembly through an annulus formed by the housing. A radial brush-seal can be arranged about the annulus to prevent outside air from unintentionally entering the chamber. The brush-seal can comprise a synthetic fiber or other suitable material.

The radiation provided to the extrudate can increase proportionally with the number of IR light sources. Further, a controller can be implemented to adjust the power level of one or more the IR light sources. The controller can be configured to automatically adjust the power level based on a skin temperature of the extrudate. The skin temperature can be measured by one or more temperature sensors, such as pyrometers.

The system can also include an air bearing system to provide vertical support to at least a portion of the extrudate following formation by the extruder. In one example, the air bearing system comprises a single air bearing providing support to the extrudate after it has been heated by the radiative heat assembly and exited the housing. Alternatively, the system can include several radiative heat assembly stages, with an air bearing to provide support following each stage.

The housing can also be configured to comprise a differential pressure assembly. The differential pressure assembly is configured to remove water vapor, generated by the drying process, from around the extrudate. The differential pressure assembly is fluidly connected to the chamber formed around the IR light sources by the housing. The differential pressure assembly can further comprise a vacuum hose to convey the water vapor away from the extrudate.

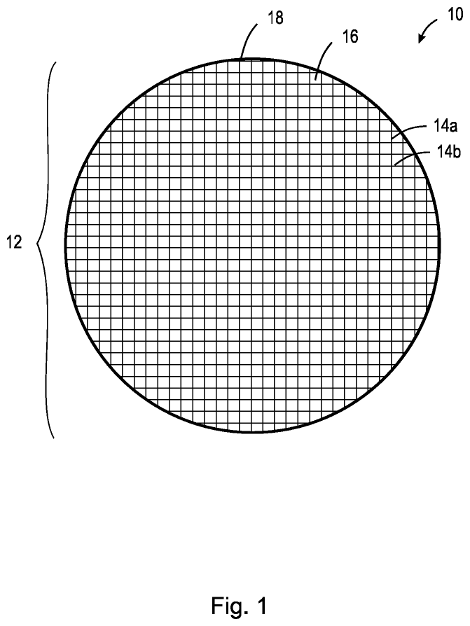

FIG. 1 shows an end view of an example of an extrudate 10 in the form of a honeycomb structure. The honeycomb structure is formed by an array 12 of intersecting walls 14. For example, FIG. 1 shows how walls 14a (extending in a first direction) and walls 14b (extending in a second direction) intersect. The intersecting walls 14 form a plurality of channels 16. The walls 14 are illustrated as defining a square shape for the channels 16, although other channel shapes can be used, such as hexagonal, rectangular, triangular, or other polygons, or combinations thereof. As shown in FIG. 1, the channels can extend to the outer periphery 18 of the extrudate 10. In this example, the extrudate 10 is formed from a wet mixture, such as a ceramic forming mixture, and which may be referred to as a batch mixture. The honeycomb structure results in the extrudate 10 being particularly vulnerable to deformation following high-speed extrusion, e.g., due to the thin thicknesses of the walls 14 and the generally low strength of green ceramic materials, particularly when the green ceramic materials are still wet, such as immediately after extrusion. Thus, systems and methods for quickly drying and hardening the extrudate 10 may be beneficial to prevent deformation during or immediately following extrusion. In a further example, the extrudate 10 may also comprise an organic binder or polymer solution, such as methylcellulose or other polymer solution. Thus, in addition to removing some of the moisture from the extrudate 10, the aforementioned systems for drying the extrudate may also assist in gelling the organic binder or polymer solution on the exposed surfaces of the extrudate 10, thereby providing additional green strength.

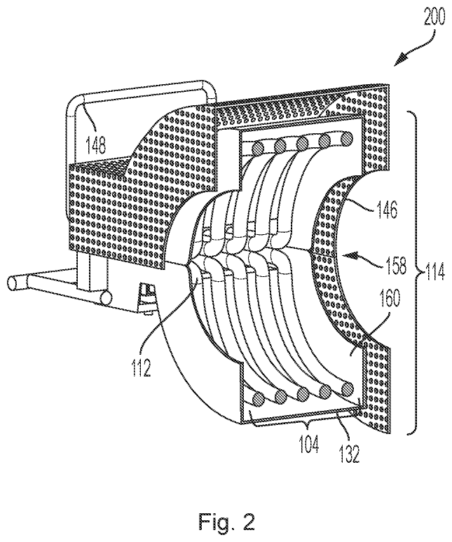

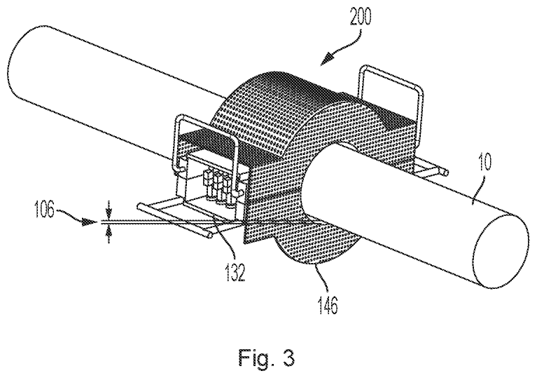

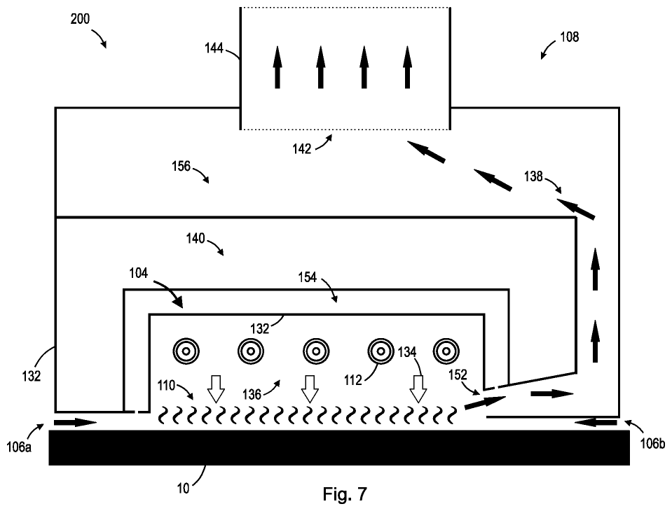

FIG. 2 is a cross-sectional view of a drying assembly 200. The drying assembly 200 comprises a radiative heat assembly 104. As can be seen in FIG. 2, the radiative heat assembly 104 includes five IR light sources 112 (such as IR lamps), although different numbers of IR light sources 112 can be used depending on the application. The IR light sources 112 generate radiation 134 (as illustrated in FIG. 7) to heat (and dry) the surface of the extrudate 10 (illustrated in FIG. 3). The radiation corresponding to the IR light sources 112 can be generated by one or more light emitting diodes (LEDs) embedded within the IR light sources 112. The IR light sources 112 can be curved to form one or more rings 114 around the outer periphery of the extrudate 10. The rings 114 can have a shape that corresponds to and/or is complementary with respect to the outer peripheral shape of the extrudate 10 (e.g., a circular shape corresponding to a cylindrically-shaped extrudate). The ring 114 configuration allows the IR light sources 112 to heat the outer surface of the extrudate 10 more evenly. The IR light sources 112 can be arranged into other shapes and/or configurations based on the shape of the extrudate 10, such as one or more spirals, one or more gangs of loops, or one or more hemi-circle pairs. In an alternate example, the radiative heat assembly 104 includes a spiral of halogen light sources, rather than IR light sources 112. In further examples, the halogen light sources may be arranged as a gang of loops or in hemi-circle pairs.

The drying assembly 200 can further comprise a housing 132. The radiative heat assembly 104 may be surrounded by the housing 132. The housing 132 can be configured to enhance the efficiency of the IR light sources 112, e.g., by reflecting the radiation 134 generated by the IR light sources 112 towards the extrudate 10. Accordingly, the housing 132 in embodiments comprises a reflective material, such as a metal. In other examples, the housing 132 can comprise any other appropriate material.

In a further example, the housing 132 can comprise an inner housing surface 160. This inner housing surface 160 may face the IR light sources 112. In this example, the inner housing surface 160 can be polished to improve the reflection of the radiation 134 generated by the IR light sources 112.

The drying assembly 200 can further comprise a safety shield 146 surrounding the housing 132. The safety shield 146 is arranged to prevent an operator from touching the housing 132, as, during operation, the housing 132 may become very hot due to the radiation generated by the IR light sources 112. As shown in FIG. 2, the safety shield 146 can be perforated to reduce the heat retained within the safety shield 146. Further, one or more handles 148 can be mechanically coupled to either the housing 132 or the safety shield 146 to enable an operator to manipulate the drying assembly 200. The handles 148 can be configured to extend a distance from the housing 132 for safe and/or convenient manipulation by the operator. As shown in FIG. 2, the housing 132 forms an opening 158 to allow the extrudate 10 to pass through. In a further example, thermal insulation may be arranged between the safety shield 146 and the housing 132. The thermal insulation can comprise a refractory material resistant to the heat generated by the radiative heat assembly 104.

A perspective view of the drying assembly 200 and the extrudate 10 is shown in FIG. 3. For simplicity, the extrudate 10 shown in FIG. 3 omits the walls 14 and channels 16 forming the honeycomb structure as shown in FIG. 1. The extrudate of FIG. 3 may comprise any appropriate internal structure and/or materials. In the illustrated embodiment, a gap or annulus 106 defines the clearance between the opening 158 formed by the housing 132 and the extrudate 10. This gap 106 allows the extrudate 10 to enter the housing 132, be heated by the radiative heat assembly 104, and then exit the housing 132. Preferably, the gap 106 is as small as possible to prevent radiation generated by the IR light sources 112 from escaping the housing 132. In some examples, the gap 106 varies in width about the inner circumference of the opening 158.

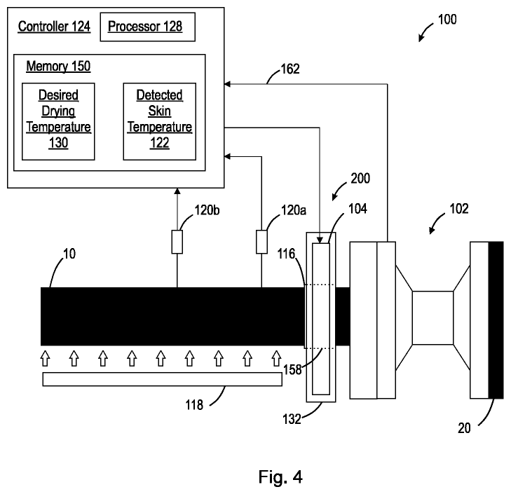

FIGS. 4-6 illustrate various schematics of a system 100 for manufacturing the extrudate 10. The schematics are not drawn to scale, and are solely for explanatory purposes. The system 100 comprises an extruder 102. In one example, the extruder 102 can be a high-speed extruder capable of extrusion speeds greater than or equal to 2 inches per second. In some examples, the extruder 102 may be a twin-screw extruder. In other examples, the extruder 20 may be any other extruder 20 capable of high-speed extrusion.

The extruder 102 receives a wet mixture 20. The wet mixture 20 can be a ceramic forming mixture as described herein. The extruder 102 forces the wet mixture 20 through a die to form the extrudate 10, such as the honeycomb structure shown in FIG. 1. As the extrudate 10 exits the extruder 102, the extrudate 10 passes through the radiative heat assembly 104 of the drying assembly 200. As described above, the radiative heat assembly 104 comprises one or more heat sources, such as IR light sources 112 (as shown in FIG. 2). The IR light sources 112 heat the surface of the extrudate 10, e.g., causing the extrudate 10 to dry and harden and/or an organic binder in the material of the extrudate 10 to gel.

The drying assembly 200 can comprise a brush-seal 116, such as a radial brush-seal. The brush-seal 116 can be arranged between the opening 158 formed by the housing 132 surrounding the radiative heat assembly 104 and the extrudate 10. As the extrudate 10 passes through the opening 158, the brush-seal 116 can be arranged about the opening 158 to prevent outside air from unintentionally entering the chamber 136 (as illustrated in FIG. 7) formed by the housing 132 of the radiative heat assembly 104. Preferably, the brush-seal 116 is soft enough to avoid deforming the extrudate 10 as it passes through the brush-seal 116 surrounding opening 158. In one example, the brush-seal 116 comprises a synthetic fiber. In a preferred example, the brush-seal 116 comprises a temperature-stable material.

As the extrudate 10 exits housing 132 having been heated by the radiative heat assembly 104, the extrudate 10 can be supported by an air bearing 118. The air bearing 118 uses pressurized gas (e.g., air) to allow the extrudate 10 to slide along the length of the air bearing 118 to the next manufacturing stage.

The system 100 can further include a pair of temperature sensors 120, such as pyrometers, with two such sensors designated in the drawings with the reference numerals 120a, 120b. The temperature sensors 120a, 120b are configured to measure the temperature of the skin of the extrudate 10. The temperature sensors 120a, 120b convey the measured temperature to a controller 124. The controller 124 includes a memory 150 and a processor 128. The memory 150 stores a desired drying temperature 130 which may be set by an operator through a variety of means, such as a graphical user interface. The desired drying temperature 130 can be a single temperature value, a range of temperature values, or a temperature profile corresponding to the temperature sensor 120 contact location(s) on the extrudate 10. The desired drying temperature 120 can vary based on a wide array of factors, such as the overall dimensions of the extrudate 10, the internal structure of the extrudate 10, and the final application of the extrudate. In one example, the desired drying temperature 130 for the extrudate 10 is between 96° C. and 162° C. In another example, the desired drying temperature is between 86° C. and 120° C.

The processor 128 evaluates the temperatures measured across the extrudate 10 to determine a detected skin temperature 122. In one example, the detected skin temperature 122 is an array of several temperature measurements taken along the extrudate 10. The processor then compares the desired drying temperature 130 to the detected skin temperature 122. If the detected skin temperature 122 is lower than the desired drying temperature 130, the processor 128 can increase the power supplied to the IR light sources of the radiative heat assembly 104 to increase the radiation incident upon the extrudate 10. Similarly, if the detected skin temperature 122 is higher than the desired drying temperature 130, the processor 128 can decrease the power supplied to the IR light sources 112 of the radiative heat assembly 104 to lower the radiation incident upon the extrudate 10.

In embodiments, the controller 124 can be utilized to implement one or more safety features. For instance, the controller 124 can be configured to determine that the extrusion of the extrudate 10 has stalled based on input 162 received from the extruder 20. Upon determining that the extrusion has stalled, the controller 124 can turn off the IR light sources 112 of the radiative heat assembly 104. Similarly, if the controller 124 determines that the detected skin temperature 122 of the extrudate 10 is increasing at an undesirably high rate, the controller 124 can also turn off the IR light sources 112.

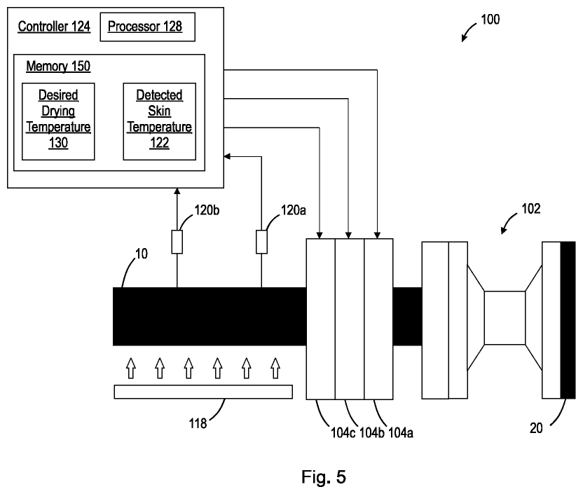

FIG. 5 illustrates a variation of the system 100. The system 100 of FIG. 5 includes three consecutive radiative heat assemblies 104a, 104b, 104c, each arranged generally as described with respect to the heat assembly 104 herein. The radiative heat assemblies 104a, 104b, 104c can be grouped together in this way to increase the radiation 134 (as illustrated in FIG. 7) provided to the extrudate 10 as it exits the extruder 102. In this example, all three radiative heat assemblies 104 can be arranged within the housing of a single drying assembly 200. In an alternate example, the radiative heat assemblies 104a, 104b, 104c can each be arranged in individual drying assemblies 200. Other combinations of arranging the radiative heat assemblies are possible depending on the application. Each of the radiative heat assemblies 104a, 104b, 104c can be communicatively coupled to the controller 124, allowing the controller 124 to adjust the radiation 134 generated by each radiative heat assembly 104a, 104b, 104c on an individual basis for fine tuning purposes. In further examples, any number of radiative heat assemblies 104 can be used achieve the desired heating.

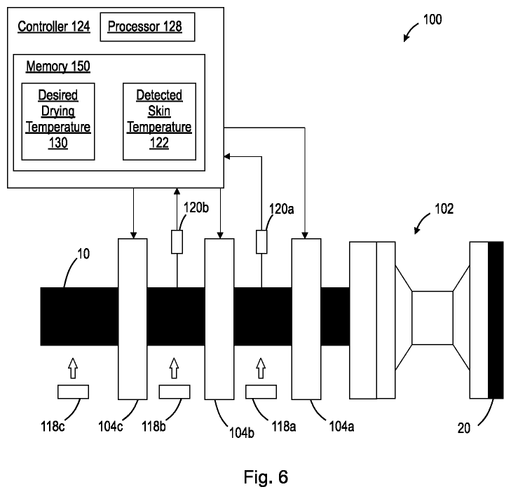

FIG. 6 illustrates a further variation of the system 100. The system 100 of FIG. 6 includes three radiative heat assemblies 104a, 104b, 104c spaced out into individual stages. An air bearing 118a, 118b, 118c follows each radiative heat assembly 104a, 104b, 104c. As with FIG. 5, each of the radiative heat assemblies 104a, 104b, 104c can be communicatively coupled to the controller 124, allowing the controller 124 to adjust the radiation 134 (as illustrated in FIG. 7) generated by each radiative heat assembly 104a, 104b, 104c on an individual basis for fine tuning purposes. Spacing out the radiative heat assemblies 104a, 104b, 104c allows for the controller 124 and/or operator to create a desired temperature profile over a longer application area for increased heat penetration. In further examples, any number and/or spacing combinations thereof of radiative heat assemblies 104 may be used achieve the desired heating.

FIG. 7 illustrates an example differential pressure assembly 108. The differential pressure assembly 108 is configured to remove water vapor 110 from around the extrudate 10. This water vapor 110 is created by the radiation 134 generated by the IR light sources 112 heating the extrudate 10 as it passes through the housing 132. As the extrudate 10 is formed from a wet mixture (such as a ceramic forming mixture), heating the extrudate 10 causes a portion of the liquid vehicle (e.g., water) present within the wet mixture to vaporize, resulting in vapor 110 forming around the extrudate 10. This vapor 110 in the case of water vapor results in humidity in the chamber 136 around the extrudate 10. This humidity may be semi-infrared opaque. This humidity can impact evaporation and non-radiative heat transfer within the chamber 136.

As shown in FIG. 7, the differential pressure assembly 108 can be formed in the housing 132 of the drying assembly 200, and comprises gaps 106a, 106b between the housing 132 and the extrudate 10 at opposite axial ends of the assembly 108. The differential pressure assembly 108 can further comprise a suction inlet 152, a thermal break 154, an insulated section 140, a plenum 156, and a top opening 142. A pressure source 144 can be inserted into the top opening 142. For example, the pressure source 144 can be a negative pressure source, such as a vacuum tube. In the example of FIG. 7, the width of the suction inlet 152 is significantly narrower than the width of the top opening 142. For example, the width of the suction inlet can be 0.25 inches, while the width of the top opening can be 2.5 inches. This difference in width of the suction inlet 152 and the top opening 142 results in a differential pressure. This differential pressure creates an air flow 138 from the chamber 136 formed by the housing 132 to the top opening 142, thereby removing a portion of water vapor 110 from around the extrudate 10.

Further, the gaps 106a, 106b can be different widths. The width of the gaps 106a, 106b can be defined as the distance from the bottom of the housing 132 to the extrudate 10 passing through the chamber 136. In one example, gap 106a can be about 0.1875 inches, while gap 106b can be about 0.125 inches.

In the example of FIG. 7, external air enters the chamber 136 through the gaps 106a, 106b. The pressure differential creates an air flow 138 through the suction inlet 152, around the insulated section 140, into the plenum 156, and through the top opening 142 to the pressure source 144. In this arrangement, the air flow 138 sucks the water vapor 110 out of the chamber 136 through the pressure source 144. This pressure differential may be impacted by the gas volume of the water vapor 110 within the chamber 136 generated by the heating of the extrudate 10.

In a further example, the differential pressure assembly of FIG. 7 could be reconfigured to direct the air flow 138 towards extrudate 10. In this configuration, the water vapor 110 can be effectively blown out through the gaps 106a, 106b, rather than sucked out by the pressure source 144 when arranged as a vacuum as described above. For example, the pressure source 144 can be a positive pressure source, such that the air flow 138 is directed in the opposite direction of that shown in FIG. 7 (i.e., in a direction toward the extrudate 10 in the chamber 136), and then the air flow 134 is directed out of the chamber 136 through the gaps 106a, 106b also in a direction opposite to that shown in FIG. 7.

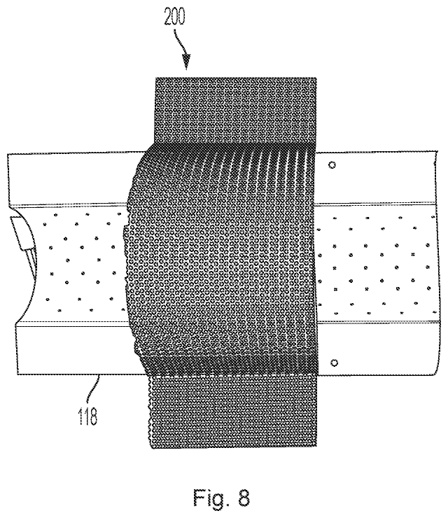

FIG. 8 depicts the drying assembly 200 arranged with an air bearing 118. In this embodiment, the extrudate 10 entering and exiting the drying assembly 200 is supported by the air bearing 118. Further, radiative heat assembly 104 (e.g., as illustrated in FIG. 2) can be arranged within a gap in the air bearing 118, thus enabling the IR light sources 112 (e.g., as illustrated in FIG. 2) of the radiative heat assembly 104 to heat the entire surface of the extrudate 10.

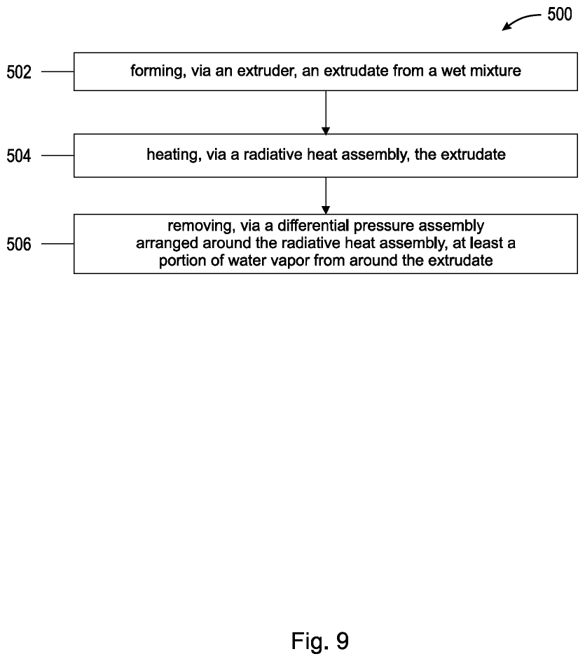

FIG. 9 is a method 500 for manufacturing an extrudate. The method 500 comprises forming 502, via an extruder, an extrudate from a wet mixture, such as a ceramic forming mixture. The method 500 further comprises heating 504 via a radiative heat assembly, the extrudate. The method 500 further comprises removing 506, via a differential pressure assembly arranged around the radiative heat assembly, at least a portion of water vapor from around the extrudate.

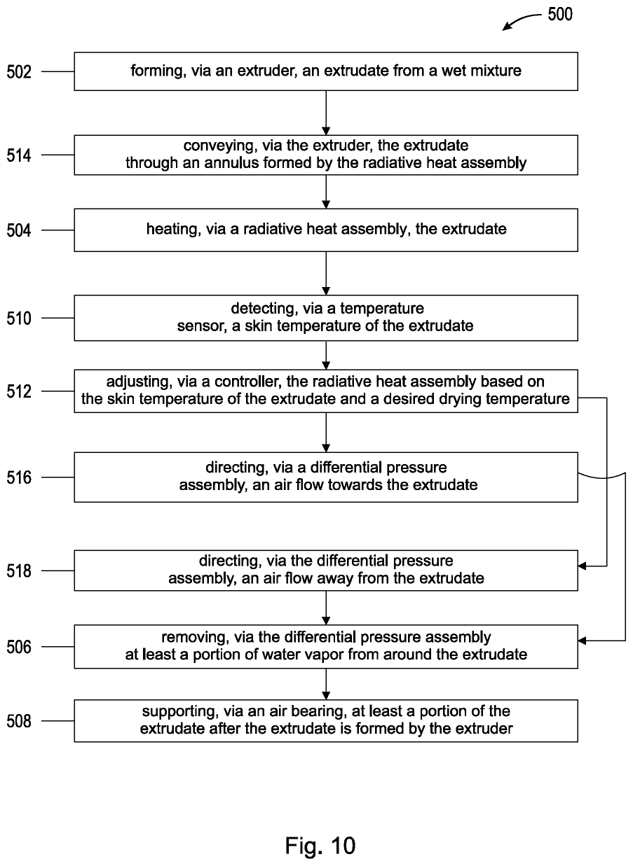

FIG. 10 is a more detailed example embodiment of method 500 for manufacturing an extrudate. In this embodiment, the method 500 comprises forming 502, via an extruder, an extrudate from a wet mixture. According to an example, the method 500 further comprises conveying 514, via the extruder, the extrudate through an annulus formed by the radiative heat assembly. The method 500 further comprises heating 504, via a radiative heat assembly, the extrudate. According to an example, the method 500 further comprises detecting 510, via a temperature sensor, a skin temperature of the extrudate. According to an example, the method 500 further comprises adjusting 512, via a controller, the radiative heat assembly based on the skin temperature of the extrudate and a desired drying temperature.

According to an example, the method 500 further comprises directing 516, via a differential pressure assembly arranged around the radiative heat assembly, an air flow towards the extrudate. In an alternative example, the method 500 further comprises directing 518, via the differential pressure assembly, the air flow away from the extrudate.

The method 500 further comprises removing 506, via the differential pressure assembly, at least a portion of water vapor from around the extrudate. According to an example, the method 500 further comprises supporting 508, via an air bearing, at least a portion of the extrudate after the extrudate is formed by the extruder.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A method for manufacturing an extrudate, comprising:
forming, via an extruder, an extrudate from a wet mixture;
heating, via a radiative heat assembly, the extrudate; and
removing, via a differential pressure assembly arranged around the radiative heat assembly, at least a portion of water vapor from around the extrudate.

2. The method of claim 1, further comprising supporting, via an air bearing, at least a portion of the extrudate after the extrudate is formed by the extruder.

3. The method of claim 1, further comprising detecting, via a temperature sensor, a skin temperature of the extrudate.

4. The method of claim 3, further comprising adjusting, via a controller, the radiative heat assembly based on the skin temperature of the extrudate and a desired drying temperature.

5. The method of claim 1, further comprising conveying, via the extruder, the extrudate through an annulus formed by the radiative heat assembly.

6. The method of claim 1, further comprising directing, via the differential pressure assembly, an air flow towards the extrudate.

7. The method of claim 1, further comprising directing, via the differential pressure assembly, an air flow away from the extrudate.

8. The method of claim 1, wherein the radiative heat assembly comprises one or more infrared (IR) light sources.

9. A system for manufacturing an extrudate, comprising:
an extruder configured to form an extrudate from a wet mixture;
a radiative heat assembly configured to heat the extrudate; and
a differential pressure assembly configured to remove at least a portion of water vapor from around the extrudate.

10. The system of claim 9, wherein the radiative heat assembly comprises one or more infrared (IR) light sources.

11. The system of claim 9, wherein the one or more IR light sources are arranged as one or more rings around the extrudate.

12. The system of claim 9, wherein the wet mixture is a ceramic forming mixture.

13. The system of claim 9, wherein the extrudate has a honeycomb structure.

14. The system of claim 9, further comprising an air bearing configured to support at least a portion of the extrudate after the extrudate is formed by the extruder.

15. The system of claim 9, further comprising:
a temperature sensor configured to detect a skin temperature of the extrudate;
a controller configured to adjust the radiative heat assembly based on the skin temperature of the extrudate and a desired drying temperature; and
a housing arranged around the radiative heat assembly.

16. (canceled)

17. The system of claim 15, wherein the housing is configured to reflect at least a portion of radiation generated by the radiative heat assembly towards the extrudate.

18. The system of claim 15, wherein the housing forms a chamber around one of more IR light sources of the radiative heat assembly.

19. The system of claim 18, wherein the differential pressure assembly directs an air flow out of the chamber via a gap between the housing and the extrudate.

20. The system of claim 18, wherein the differential pressure assembly directs an air flow into the chamber via a gap between the housing and the extrudate.

21. The system of claim 15, further comprising a brush-seal arranged between an annulus of the housing and the extrudate.

22. The system of claim 9, wherein the differential pressure assembly is further configured to direct an air flow directed towards the extrudate.

23. The system of claim 9, wherein the differential pressure assembly is further configured to direct an air flow directed away from the extrudate.
